(19) United States
(12) Patent Application Publication
(10) Pub. No.: US 2015/0128820 A1
(43) Pub. Date: May 14, 2015

(54) SYSTEM FOR APPLYING A PRINTING LIQUID OR PRINTING ADJUVANT TO A GRAVURE ROLLER

(71) Applicant: COMEXI GROUP INDUSTRIES S.A.U., Riudellots De La Selva (Girona) (ES)

(72) Inventors: Carles Masgrau Lagresa, Porqueres (Girona) (ES); David Valverde Milan, Llagostera (Girona) (ES)

(73) Assignee: COMEXI GROUP INDUSTRIES S.A.U., Riudellots De La Selva (Girona) (ES)

(21) Appl. No.: 14/396,883

(22) PCT Filed: Mar. 21, 2013
(86) PCT No.: PCT/ES2013/000074

§ 371 Date: Jan. 26, 2015

(30) Foreign Application Priority Data
Apr. 26, 2012 (ES) P201230622

(51) Int. Cl. B41F 31/00; B41F 31/04; B41F 13/11

(52) U.S. Cl. CPC B41F 31/005; B41F 13/11; B41F 31/04
USPC 101/350.6

(57) ABSTRACT

The system for applying a printing liquid or a printing auxiliary liquid to a rotogravure roller comprises a vat (B) containing an adhesive, lacquer or varnish (L) constituting the printing liquid or printing auxiliary liquid, a closed-chamber doctor blade device (D) communicating with the inside of the vat (B) by means of conduits (C1-C5) forming a closed circuit configured and arranged so as to extract the adhesive, lacquer or varnish (L) from the vat (B) through a first conduit (C1) and to apply same on the outer surface of the rotogravure roller (R), and to remove the leftover adhesive, lacquer or varnish (L) from the closed-chamber doctor blade device (D) and return same to the vat (B) through a second conduit (C2), and a viscosimeter (V) in fluid communication with the inside of the conduits (C1-C5) for measuring the viscosity of the adhesive, lacquer or varnish (L) flowing therethrough.

### FIELD OF THE ART

The present invention generally relates to an application system for applying a printing auxiliary liquid, such as adhesive, lacquer or varnish, to a rotogravure roller, by means of a closed-chamber doctor blade device, and more particularly to a system comprising a viscosimeter inserted in a closed circuit associated with the doctor blade device.

In a preferred embodiment, the system comprises a carriage supporting all the elements of the system for the movement of the system from one rotogravure roller to another in the same machine or in a different machine.

### State of the Prior Art

Generally, the application of a printing liquid, i.e., ink, or a printing auxiliary liquid, i.e., adhesive, lacquer or varnish, with a rotogravure roller is performed based on immersing the rotogravure roller in a vat containing the respective liquid, thus filling the roller pits. An open doctor blade removes surplus printing liquid or printing auxiliary liquid from the surface of the roller, leaving only the liquid inside the pits, returning the leftover liquid to the vat.

This liquid is supplied to the vat from a pump driving it to the vat from a corresponding reservoir, causing liquid to spill in the vat and being returned to the reservoir, thus creating a circuit.

Nevertheless, there are more elaborate and efficient proposals which propose applying printing liquid to a rotogravure roller by means of a closed-chamber doctor blade.

This is the case described in EP0663288A1 which discloses a rotary printing machine including one or more closed-chamber doctor blade devices for supplying ink to the roller or rotogravure roller, and the corresponding removal of surplus ink.

Although it indicates that the ink to be used can have different viscosities in a range of 80 to 1000 mPa, it does not indicate that the machine includes a viscosimeter. EP0663288A1 does not propose using the closed-chamber doctor blade device for applying another kind of liquid that is not ink to the rotogravure roller either.

EP2055481A1 proposes a doctor blade device arrangement for a rotogravure printing unit comprising a support structure fixed to the printing unit comprising a mobile holding device provided to fix either a closed-chamber doctor blade device or a non-chambered doctor blade device thereto and to adjust the position thereof with respect to the side surface of the rotogravure roller.

EP2055481A1 proposes using the doctor blade device for applying ink or other substances to the rotogravure roller.

The rotogravure printing unit of EP2055481A1 also optionally comprises a viscosimeter located above the ink vessel to monitor the viscosity of the ink, although the latter is not included in the circuit including the doctor blade device, so the measurement is not made directly on the ink flowing through said circuit.

Such viscosimeter and any other known type of viscosimeter, generally located outside the printing machine, must be cleaned very carefully particularly when the substance to be applied is not an ink but an adhesive, lacquer or varnish, because if the adhesive dries up, it can damage the apparatus or give a false reading, causing the corresponding substance to be poorly mixed for subsequent use.

EP1433604A2 discloses a printing machine including ink delivery ducts and ink recovery ducts connecting an ink vat to an ink applicator device. Ink is supplied from said ink vat via said ink delivery ducts to said ink applicator device so that the ink is accumulated in the ink applicator device and applied on an outer surface of a printing roller for printing. A surplus ink is recovered from the ink applicator device and returned via said ink recovery ducts to the ink vat. A viscosimeter is arranged in the ink delivery ducts or in the ink recovery ducts for detecting the viscosity of the ink flowing therethrough.

### DISCLOSURE OF THE INVENTION

There is a need to provide an alternative to the state of the art overcoming the drawbacks therein, particularly as regards the use of viscosimeters for measuring the viscosity of the liquid applied on rotogravure rollers.

For such purpose, the present invention relates to an application system for applying a printing liquid, or a printing auxiliary liquid to a rotogravure roller, comprising as is already known a vat containing the printing liquid or printing auxiliary liquid, an applicator device communicating with the inside of the vat by means of conduits forming a circuit configured and arranged so as to extract the printing liquid or printing auxiliary liquid from the vat through a first one of said conduits and to apply same on the outer surface of a printing roller, and to remove leftover printing liquid or printing auxiliary liquid from said applicator device and return same to the vat through a second one of said conduits, and at least one viscosimeter arranged in fluid communication with the inside of the conduits for measuring the viscosity of the printing liquid or printing auxiliary liquid flowing therethrough.

Unlike the known proposals, in the system proposed by the present invention said circuit formed by said conduits is a closed circuit, said printing liquid or printing auxiliary liquid is selected among adhesive, lacquer and varnish, said applicator device is a closed-chamber doctor blade device, said printing roller is a rotogravure roller having recesses formed in a surface thereof, wherein the adhesive, lacquer or varnish applied by said closed-chamber doctor blade device fills said recesses. In addition, the system of the present invention comprises an automatic cleaning system which is connectable to said closed circuit to cause a cleaning fluid to flow therethrough for cleaning the inside of the conduits, the viscosimeter and the closed-chamber doctor blade device.

The system of the present invention is applicable to any type of machine including at least one rotogravure roller, such as a laminating machine, a lacquering machine or a varnishing machine

In one embodiment, the closed-chamber doctor blade device uses the device for fixing scraper strips by means of magnetic elements of EP1650026A1.

By means of including the viscosimeter in the actual adhesive, lacquer or varnish application circuit, the measurement of the viscosity is taken directly on the flowing liquid and not on the static liquid in the vat, so in addition to the advantages inherent to choosing such location and conditions of the liquid, taking viscosity measurements does not involve adding more time to the entire process, since viscosity measurements are taken during the actual process of applying the liquid to the rotogravure roller.

According to a preferred embodiment, the viscosimeter is arranged inserted in said first conduit.

The system comprises pumps and valve devices arranged in said conduits for the controlled flow of the adhesive, lacquer or varnish.

When the automatic cleaning system is connected to the closed circuit, the cleaning fluid (such as a solvent) is caused to flow therethrough for cleaning the inside of the conduits, the viscosimeter and the doctor blade device. By combining the flow of the cleaning fluid with the rotation of the rotogravure roller, the rotogravure roller will also thus be cleaned in an automatic manner.

By means of including such automatic cleaning system, it is not necessary to add more cleaning operations and time to the entire process, since the viscosimeter is cleaned at the same time as the rest of the elements of the adhesive, lacquer or varnish application system, i.e., at the same time as the conduits and the doctor blade device, the entire cleaning process generally being carried out in no more than fifteen minutes when the application liquid is an adhesive.

According to a variant of said embodiment, the automatic cleaning system comprises at least one vessel containing said cleaning fluid and a first duct having a first end arranged inside said vessel and a second end connected to said first conduit through at least one valve device, and at least one pump arranged for pumping the cleaning fluid from the vessel containing same into the first conduit; and a reservoir receiving said cleaning fluid and a second duct having a first end arranged inside said reservoir receiving said cleaning fluid and a second end connected to said second conduit through at least one valve device so that the cleaning fluid soiled by the residues of the adhesive, lacquer or varnish is channeled to and received by the reservoir receiving said cleaning fluid from the second conduit.

In another embodiment, the system of the present invention comprises a viscosity adjustment system for adjusting the viscosity of the adhesive, lacquer or varnish

The system proposed by the present invention generally comprises control means configured and arranged for controlling the pumps and the valve devices of the closed circuit and/or of the automatic cleaning system and/or of the viscosity adjustment system.

According to one embodiment, the system comprises a mobile support structure, such as a carriage, on which there are arranged all the elements of the system for the movement and positioning thereof with respect to the rotogravure roller on which the adhesive, lacquer or varnish is applied, the system thus being able to be moved from one rotogravure roller to another in the same machine or in a different machine to apply adhesive, lacquer or varnish thereon.

### BRIEF DESCRIPTION OF THE DRAWINGS

The foregoing and other advantages and features will be better understood from the following detailed description of several embodiments in reference to the attached drawing which must be considered in an illustrative and non-limiting manner, in which:

FIG. 1 schematically illustrates the system proposed by the present invention for an embodiment comprising the previously mentioned automatic cleaning system.

### DETAILED DESCRIPTION OF EXEMPLARY EMBODIMENTS

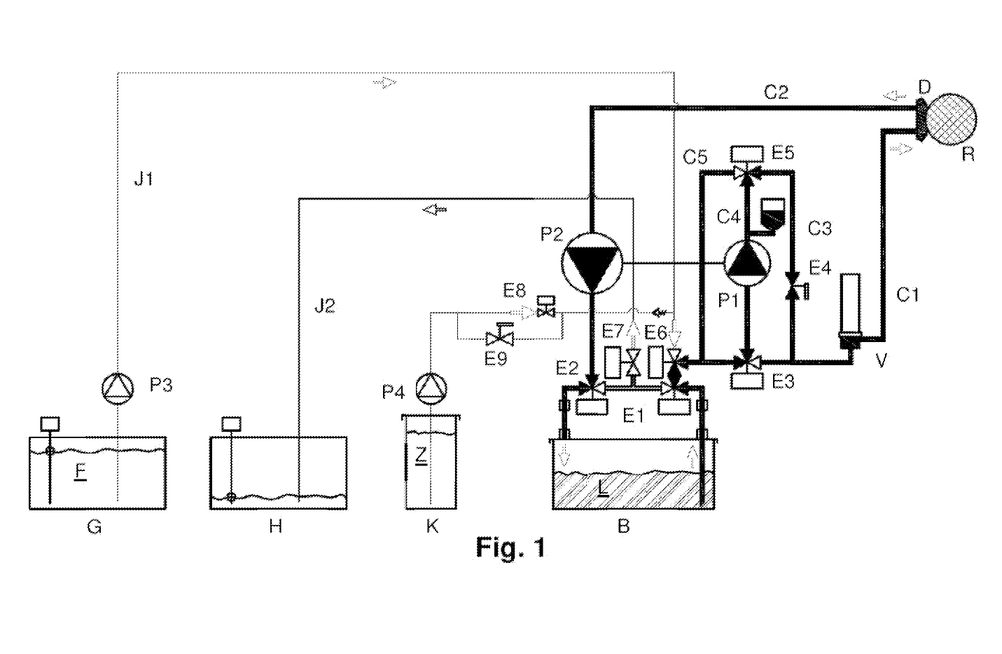

FIG. 1 illustrates an exemplary embodiment of the application system proposed by the present invention, where it comprises:
a vat B containing and adhesive, lacquer or varnish L, and
a closed-chamber doctor blade device D communicating with the inside of the vat B by means of conduits C1-C5 forming a closed circuit, which is configured and arranged so as to extract the adhesive, lacquer or varnish L from the vat B through a first conduit C1 and to apply same on the outer surface of the rotogravure roller R filling recesses or pits (not illustrated) defined therein, and to remove the leftover adhesive, lacquer or varnish L from said application and return same to the vat B through a second conduit C2.

The system comprises a viscosimeter V arranged inserted in the first conduit C1 and in fluid communication with the inside of the conduits for measuring the viscosity of the printing liquid flowing therethrough.

The system comprises pumps P1, P2 and valve devices E1-E5 arranged in the conduits C1-C5 for the controlled flow of the adhesive, lacquer or varnish L, pumping it from the vat B to the doctor blade device D and vice versa (referring to leftover or surplus adhesive, lacquer or varnish L that does not fill the pits).

FIG. 1 also illustrates an automatic cleaning system for cleaning the inside of the conduits C1-C5, the viscosimeter V and the doctor blade device D, comprising:
a vessel G containing a cleaning fluid F, such as a solvent, and a first duct J1 having a first end arranged inside the vessel G and a second end connected to the first conduit C1 through a valve device E6, and a pump P3 arranged for pumping the cleaning fluid F from the vessel G into the first conduit C1; and
a reservoir H receiving the cleaning fluid F and a second duct J2 having a first end arranged inside said reservoir H receiving said cleaning fluid F and a second end connected to the second duct J2 through a valve device E7 so that the cleaning fluid F soiled by the residues of the adhesive, lacquer or varnish L is channeled to and received by the reservoir H receiving said cleaning fluid F from the second conduit C2.

The circuit composed by conduits C3 to C5 along with valves E3 to E5 alternates the supply of adhesive, lacquer or varnish to the closed-chamber doctor blade device D during the application process with the emptying out of adhesive, lacquer or varnish during the cleaning process.

For the embodiment illustrated in FIG. 1, the system also comprises a viscosity adjustment system for adjusting the viscosity of the adhesive, lacquer or varnish L comprising an auxiliary circuit for viscosity rectification formed by an auxiliary vessel K containing a rectifying liquid Z and a respective duct J3 having a first end arranged inside said auxiliary vessel K and a second end connected to the first conduit C1 through at least one valve device E8, E9, and a pump P4 arranged for pumping the rectifying liquid Z from the auxiliary vessel K into the first conduit C1.

Said rectifying liquid Z is an evaporable diluent for the adhesive, lacquer or varnish L.

The scope of the invention is defined in the attached claims.

1-12. (canceled)

13. An application system for applying a printing liquid or a printing auxiliary liquid to a rotogravure roller, of the type comprising:
at least one vat containing said printing liquid or printing auxiliary liquid;
an applicator device arranged for applying the printing liquid or printing auxiliary liquid on an outer surface of a rotogravure roller;
conduits forming a closed circuit configured and arranged for conveying the printing liquid or printing auxiliary liquid from the vat to said applicator device through a first conduit of said conduits and to return leftover printing liquid or printing auxiliary liquid from the applicator device to the vat through a second conduit of said conduits; and
at least one viscosimeter arranged in fluid communication with the inside of the conduits for measuring the viscosity of the printing liquid or printing auxiliary liquid flowing therethrough,
the system being characterized in that:
said circuit formed by said conduits is a closed circuit;
said printing liquid or printing auxiliary liquid is selected among adhesive, lacquer and varnish;
said applicator device is a closed-chamber doctor blade device;
said printing roller is a rotogravure roller having recesses formed in a surface thereof, wherein the adhesive, lacquer or varnish applied by said closed-chamber doctor blade device fills said recesses; and
an automatic cleaning system is included, said automatic cleaning system being connectable to said closed circuit for causing a cleaning fluid to flow through the closed circuit for cleaning the inside of the conduits, the viscosimeter and the closed-chamber doctor blade device.

14. The system according to claim 13, wherein said viscosimeter is arranged inserted in said first conduit.

15. The system according to claim 13, further comprising pumps and valve devices arranged in said conduits for the controlled flow of the adhesive, lacquer or varnish in the closed circuit.

16. The system according to claim 15, further comprising means configured and arranged for controlling said pumps and said valve devices of the closed circuit.

17. The system according to claim 15, further comprising pumps and valve devices arranged in said conduits for the controlled flow of the adhesive, lacquer or varnish in the closed circuit.

18. The system according to claim 17, further comprising means configured and arranged for controlling said pumps and said valve devices of the closed circuit.

19. The system according to claim 13, wherein said cleaning fluid is a solvent.

20. The system according to claim 13, wherein said automatic cleaning system comprises:
at least one vessel containing said cleaning fluid and a first duct having a first end arranged inside said vessel and a second end connected to said first conduit through at least one valve device, and at least one pump arranged for pumping the cleaning fluid from the vessel containing same into the first conduit; and
a reservoir receiving said cleaning fluid and a second duct having a first end arranged inside said reservoir receiving said cleaning fluid and a second end connected to said second conduit through at least one valve device for conveying the cleaning fluid soiled by residues of the adhesive, lacquer or varnish from the second conduit to the reservoir in which the adhesive, lacquer or varnish is received.

21. The system according to claim 20, wherein said cleaning fluid is a solvent.

22. The system according to claim 20, further comprising means configured and arranged for controlling said pump and said valve devices of the automatic cleaning system.

23. The system according to claim 13, further comprising a viscosity adjustment system for adjusting the viscosity of the adhesive, lacquer or varnish, comprising an auxiliary circuit for viscosity rectification comprising an auxiliary vessel containing a rectifying liquid and a respective duct having a first end arranged inside said auxiliary vessel and a second end connected to the first conduit through at least one valve device, and at least one pump arranged for pumping the rectifying liquid from the auxiliary vessel into the first conduit.

24. The system according to claim 23, wherein said rectifying liquid is an evaporable diluent for the adhesive, lacquer or varnish.

25. The system according to claim 23, further comprising means configured and arranged for controlling said pump (and said at least one valve device of the viscosity adjustment system.

26. The system according to claim 13, further comprising a mobile support structure on which there are arranged all the elements of the system for the movement and positioning thereof with respect to the rotogravure roller on which the adhesive, lacquer or varnish is to be applied.

27. The system according to claim 26, wherein said mobile support structure is a carriage.
